(19) United States
(12) Patent Application Publication
(10) Pub. No.: US 2026/0314784 A1
(43) Pub. Date: Oct. 15, 2026

(54) HAIR STYLING APPLIANCE WITH LONGITUDINAL HEATER

(71) Applicant: Dyson Operations Pte. Ltd., Singapore (SG)

(72) Inventors: Ishika KAJARIA, Singapore (SG); Chidambaresan KRISHNASWAMI, Singapore (SG); Jia Hwai WONG, Singapore (SG); Danyal Ahmad SIDDIQUI, Swindon (GB); Brian Man-Lok CHAN, Singapore (SG); Al Salcedo PINEDA, Singapore (SG); Mahesh SURENDRAN, Singapore (SG)

(21) Appl. No.: 19/482,424

(22) PCT Filed: Apr. 24, 2024
(86) PCT No.: PCT/IB2024/053993

§ 371 Date: Nov. 7, 2025

(30) Foreign Application Priority Data
May 11, 2023 (GB) 2306958.6

(51) Int. Cl. A45D 1/08; A45D 1/14; A45D 2/00; A45D 20/12

(52) U.S. Cl. CPC A45D 1/08; A45D 1/14; A45D 2/001; A45D 20/12

(57) ABSTRACT

A hair styling appliance is provided and includes first and second arms, a plenum, and a longitudinal heater. The first and second arms are coupled together for reciprocal movement towards and away from each other and are arranged to receive hair within a region between each other. A plenum is disposed within at least one of the first and second arms and includes an air inlet for receiving airflow from a fan unit and an air outlet for emitting airflow towards hair within the region. The longitudinal heater extends along the air outlet within the plenum for heating air before it exits the air outlet. The heater may include at least one heating element, the at least one heating element having a first heating zone with a first power density and a second heating zone with a second power density lower than the first power density.

### BACKGROUND

Heated hair styling appliances are designed to use the action of heat, mechanical means and/or airflow to form hair into a desired shape or style.

A hair straightener can utilise heated plates attached to pivoted arms that can be held, by a user, in a closed position with a tress of hair clamped between the heated plates. The tress of hair can be styled into a changed shape once the hair is heated above a transition temperature.

### SUMMARY

In accordance with an aspect, there is provided a hair styling appliance comprising:
a first arm and a second arm coupled together for reciprocal movement towards and away from each other, and arranged to receive hair within a region between each other;
a plenum disposed within at least one of the first arm and the second arm, the plenum comprising an air inlet for receiving airflow from a fan unit and an air outlet for emitting airflow towards hair within the region; and
a longitudinal heater extending along the air outlet within the plenum for heating air before it exits the air outlet;
wherein the heater comprises at least one heating element, the at least one heating element comprising:
   a first heating zone having first power density; and
   a second heating zone having a second power density lower than the first power density;
the heater being configured and positioned such that, when the hair styling appliance is in use, air exiting the outlet having been heated by the first heating zone is closer in temperature to air exiting the outlet having been heated by the second heating zone than would be the case if the first and second heating zones had the same power density.

The use of such a heater may allow for improved temperature control of air exiting the outlet.

The at least one heating element may be more densely concentrated in the first heating zone than the second heating zone.

A more densely concentrated heating element may allow for greater heat output, and hence greater power density in the first heating zone than the second.

The or each heating element may comprise a coil, wherein a winding density of the coil is higher within the first heating zone than the second heating zone.

A higher winding density may allow for greater heat output, and hence greater power density in the first heating zone than the second.

An average resistance per unit length of the or each heating element may be higher in the first heating zone than in the second heating zone.

This allows greater power density within the first heating zone than in the second heating zone, for a given current passing through both zones.

The first power density may be a constant within the first heating zone and the second power density may be constant within the second heating zone.

This may simplify manufacture of the heater.

The power density may vary continuously over at least part of the length of the heater.

This may offer improved control of air output temperature.

Each of the first arm and the second arm may comprise an inner wall, wherein the inner walls at least partly define the region. The air outlet may extend along the inner wall of at least one of the first arm and the second arm. The heater may extend parallel, or at an oblique angle, to the air outlet.

Each of the first and second arms may comprise a leading edge, past which hair enters the region while the hair is being pulled through the hair styling appliance in use, and a trailing edge, past which hair leaves the region while the hair is being pulled through the hair styling appliance in use, wherein the air outlet is disposed closer to the trailing edge than the leading edge.

A cross-sectional area of the plenum may reduce in a direction away from the air inlet, and the heater may be positioned such that the first heating zone is closer than the second heating zone to the air inlet.

The plenum may be at least partly defined by a first wall adjacent the air outlet, and a second wall opposing the first wall, and the first wall may be at an acute angle relative to the second wall.

The first and second arms may terminate at respective tips, and the first and second walls may converge towards the tip(s) of the arm or arms within which the plenum(s) are disposed.

### BRIEF DESCRIPTION OF THE DRAWINGS

FIG. 1 is a side elevation of a hair styling appliance;

FIG. 2 is an end elevation of the hair styling appliance of FIG. 1;

FIG. 3 is a cross-section through line III-III of the hair styling appliance of FIG. 1;

FIG. 4 is a perspective view of the hair styling appliance of FIG. 1 in a closed position;

FIG. 5 is a perspective view of the hair styling appliance of FIG. 1 in an open position;

FIG. 6 is a simplified version of the cross section of FIG. 3;

FIG. 7 is a simplified cross-section of an alternative hair styling appliance;

FIG. 8 is a simplified cross-section of a further alternative hair styling appliance;

FIG. 9 is a simplified cross-section of a further alternative hair styling appliance;

FIG. 10 is a simplified cross-section of a further alternative hair styling appliance;

FIG. 11 is a longitudinal vertical sectional view of the hair styling appliance of FIGS. 1 to 6, taken through FIG. 4;

FIG. 12 is a longitudinal horizontal sectional view of the hair styling appliance of FIGS. 1 to 6, taken through FIG. 4;

FIG. 13 is a plan view of a heater for use in a hair styling appliance;

FIG. 14 is a plan view of a further heater for use in a hairstyling appliance;

FIG. 15 is a detailed view of the circled portion in FIG. 13 indicated XV;

FIG. 16 is a detailed view of the circled portion in FIG. 14 indicated XVI;

FIG. 17 is a plan view of a further heater for use in a hairstyling appliance;

FIG. 18 is a plan view of a further heater for use in a hairstyling appliance;

FIG. 19 is a simplified schematic of the heater of FIG. 13 disposed in a plenum of a hairstyling appliance; and

FIG. 20 is a simplified schematic of the heater of FIG. 18 disposed in a plenum of a further hairstyling appliance.

FIG. 21 is a perspective view of a PCB connector for a heater harness for use in a hair styling appliance.

### DETAILED DESCRIPTION

Referring to the drawings, a hair styling appliance 10 comprises a first arm 12 and a second arm 14 coupled together for reciprocal movement towards and away from each other. In the illustrated example, first arm 12 and second arm 14 are pivotably mounted to a base in the form of a handle section 16, by way of respective hinges 17. First and second arms 12 and 14 are biased by springs (not shown) towards the open position, as shown in FIG. 5, and can be manually closed against the bias of the springs by a user.

Each of first arm 12 and second arm 14 terminates at a tip region 18 distal to handle section 16. Each of first and second arms 12 and 14 includes, in plan, a tapered portion 24 that narrows along its length towards tip region 18.

First and second arms 12 and 14 are arranged to receive hair within a region in the form of drying cavity 20. Drying cavity 20 is a space between first and second arms 12 and 14 within which a hair tress 22 is captured when the hair styling appliance 10 is in use, as described in more detail below.

Each of first and second arms 12 and 14 comprises a leading edge 15, past which hair enters drying cavity 20 while the hair is being pulled through the hair styling appliance 10 in use. Each of first and second arms 12 and 14 also comprises a trailing edge 19, past which hair leaves drying cavity 20 while the hair is being pulled through the hair styling appliance 10 in use.

The section of handle section 16 distal to tip region 18 is generally hollow, and includes several external holes 26 through which air passes when hair styling appliance 10 is in use. A filter 28 filters incoming air to remove dust and other particles that might damage downstream components or a user's hair.

Once through filter 28, air continues downstream through an impeller 30 that is driven by an electric motor 32. Motor 32 may be driven by a mains power supply (supplied via a cable, not shown) and/or batteries (not shown), depending upon implementation.

Downstream of motor 32, air continues through a bellows 34. Bellows 34 forks, dividing air into first and second ducts 36 and 38. Each of first and second ducts 36 and 38 includes an offset, in the form of an S-shaped portion 37 as shown in FIG. 12. Alternatively, an offset, such as an S-shaped portion, may be provided upstream of where the bellows fork. In yet another alternative, an offset, such as an S-shaped portion, may be provided in the airflow path at a similar position where only a single plenum is provided, and hence there is no need for a fork or, at least in some cases, bellows.

First duct 36 feeds air into a first plenum 40 within first arm 12 via a first air inlet 42, and second duct 38 feeds air into a second plenum 44 within second arm 14 via a second air inlet 46. Bellows 34 is at least partly formed from a resilient material, allowing the first and second ducts to bend away from each other when the hair styling appliance is in the open position shown in FIG. 5.

First plenum 40 has an outlet in the form of a first slot 48 that opens into drying cavity 20. Similarly, second plenum 44 has an outlet in the form of a second slot 50 that opens into drying cavity 20. First slot 48 and second slot 50 extend along an inner face of respective first and second arms 12 and 14. First and second slots 48 and 50 take the form of continuous apertures in the hair styling appliance 10, but may alternatively take the form of one or more discontinuous and/or differently shaped apertures disposed along drying cavity 20.

First slot 48 and second slot 50 are disposed closer to their respective trailing edges 19 than their respective leading edges 15.

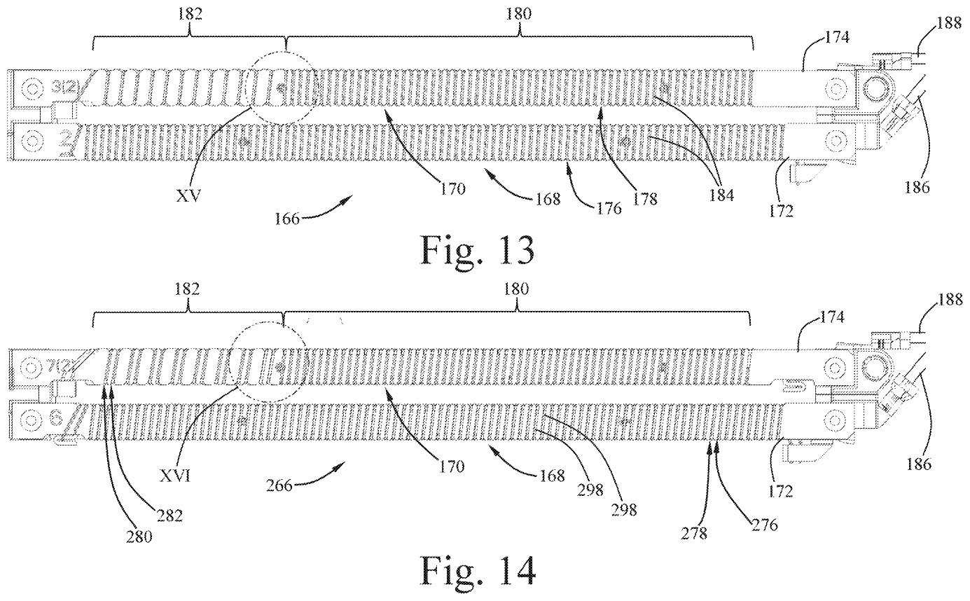

Each of first and second plenums 40 and 44 includes a longitudinally extending heater 66 for heating the airflow before it is emitted from respective first and second slots 48 and 50. Heater 66 is described in more detail below with reference to FIGS. 13-20.

As best shown in FIG. 12, each of first and second plenums 40 and 44 tapers, in plan, towards tip region 18 from where it joins its corresponding duct 36/38. This decrease in transverse cross-sectional area of the first and second plenums 40 and 44 compensates for a gradual reduction in air pressure due to increasing distance from motor 32. S-shaped portion 37 directs airflow into a region of each plenum at point distal to the first and second slots 48 and 50, which helps even out the pressure across the length of first and second plenums 40 and 44.

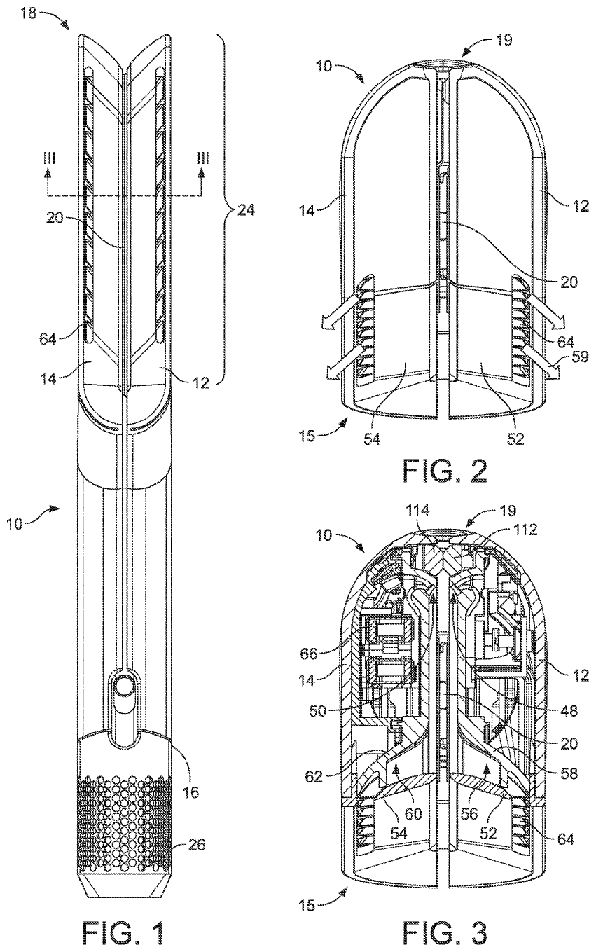

An angled wall 51 within each plenum extends along most of the plenum's length. The angle of angled wall 51 relative to the corresponding slot 48 or 50 is selected such that air is evenly redirected from the plenum through slot 48 or 50. An angle of around 6-10 degrees, more particularly around 8-9 degrees, and most particularly 8.7 degrees has been found to be effective in at least the embodiment of FIGS. 1-6.

First arm 12 includes a first air deflector 52 and second arm 14 includes a second air deflector 54. First air deflector 52 and second air deflector 54 are disposed along the first arm 12 and second arm 14, respectively, and are configured to deflect at least some of the airflow away from the hair within drying cavity 20, as described in more detail below. First air deflector 52 and second air deflector 54 are disposed closer to their respective leading edges 15 than to their trailing edges 19.

In hair styling appliance 10, first air deflector 52 partly defines a first duct 56. First duct 56 is also partly defined by a first outer surface 58 of first arm 12 disposed opposite first air deflector 52. Similarly, second air deflector 54 defines a second duct 60. Second duct 60 is similarly partly defined by a second outer surface 62 of second arm 14 disposed opposite second air deflector 54.

First and second outer surfaces 58 and 62 curve, in transverse cross-section, away from drying cavity 20. As well as giving offering a smooth path for airflow 59 passing through first and second ducts 56 and 60, the curve of first and second outer surfaces 58 and 62 is selected to encourage airflow attachment, thereby encouraging the airflow into the ducts and reducing restriction.

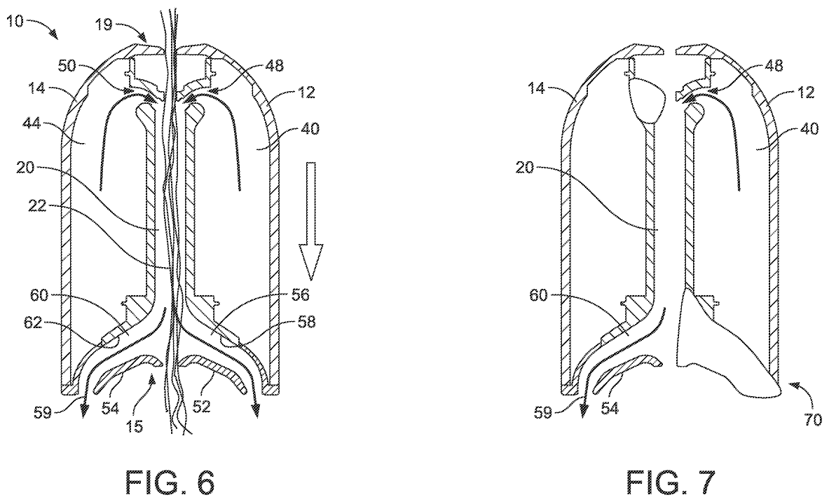

As best shown in FIGS. 3 and 6, first and second ducts 56 and 60 curve away from drying cavity 20 along at least a portion of their respective lengths. In hair styling appliance 10, first and second ducts 56 and 60 curve away in transverse cross-section (see FIGS. 3 and 6). This encourages airflow 59 away from hair within drying cavity 20.

First and second ducts 56 and 60 converge, in transverse cross-section, in a downstream direction. This accelerates airflow 59 as it leaves first and second ducts 56 and 60, which assists with air entrainment, which in turn acts to reduce the average temperature of the moving air. Reduced air temperature can offer greater user comfort, depending on the orientation with which hair styling appliance 10 is used.

First and second ducts 56 and 60 include a plurality of vanes 64, disposed between their outer surfaces 58 and 62 and air deflectors 52 and 54. Each vane 64 is angled and curved relative to a longitudinal axis of first and second arms 12 and 14, so as to deflect airflow exiting first and second ducts 56 and 60, in use, generally towards tip region 18 of hair styling appliance 10. Deflecting the airflow in this manner may improve user comfort, depending on the orientation with which hair styling appliance 10 is used.

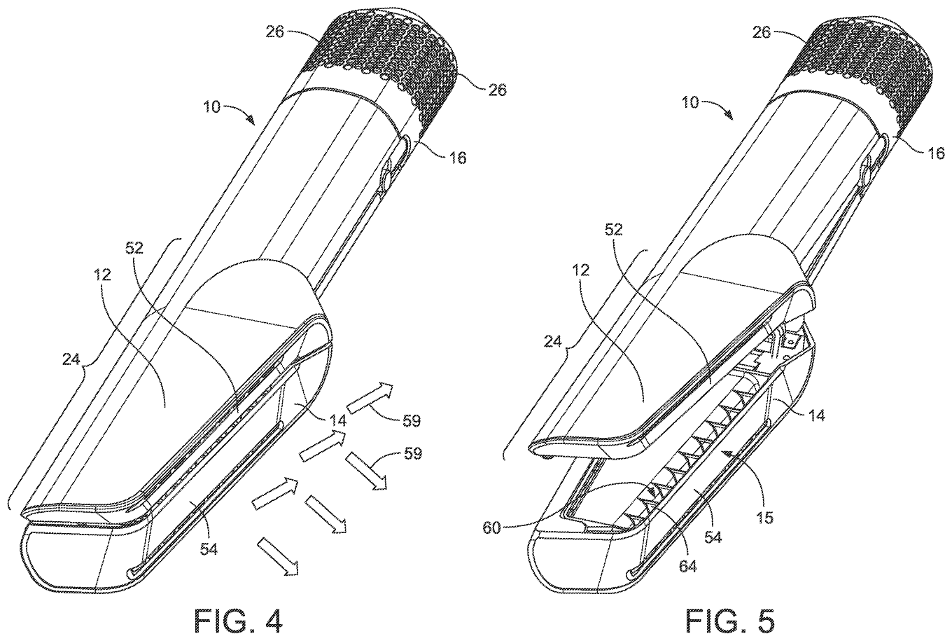

In use, while hair styling appliance 10 is in the open position shown in FIG. 5, a user places the hair tress 22 between first and second arms 12 and 14, within drying cavity 20. Typically, hair styling appliance 10 is positioned with trailing edge 19 close to the user's scalp but other positions may be selected depended upon the desired styling effect. The user then squeezes first and second arms 12 and 14 together towards the closed position shown in FIG. 4, thereby capturing the hair tress 22 within drying cavity 20.

Driven by motor 32, impeller 30 draws air through holes 26 and filter 28, then impels it downstream through bellows 34, where it is divided between first and second ducts 36 and 38. Airflow enters first plenum 40 from first duct 36 and second plenum 44 from second duct 38.

Airflow moves through first and second plenums 40 and 44, and towards respective heaters 66. The airflow is heated by heaters 66, and then exits first and second slots 48 and 50 into drying cavity 20. Due to the tapered transverse cross-section of first and second plenums 40 and 44, and S-shaped portion 37, the heated airflow exits first and second slots 48 and 50 generally evenly along their lengths.

While the user draws hair styling appliance 10 away from the scalp, the heated airflow heats and dries hair tress 22 within drying cavity 20, straightening and smoothing it. As the heated airflow leaves hair tress 22, the majority of it is directed into first and second ducts 56 and 58, although a small amount may leak through hair trapped in the gap between internal edges of first and second air deflectors 52 and 54. The airflow is directed away from hair tress 22 through first and second ducts 56 and 60, and ejected at an angle as described in more detail above.

Although hair styling appliance 10 shows both of first and second arms 12 and 14 having a plenum, outlet and air deflector, other combinations of these features may be used.

In an example, only one of first and second arms 12 and 14 includes a plenum and only one of first and second arms 12 and 14 includes an air deflector. The arm with the plenum need not be the same as the arm with the air deflector.

For example, FIG. 7 shows a transverse cross-section of a hair styling appliance 70, in which features in common with hair styling appliance 10 use the same reference signs. In hair styling appliance 70, second arm 14 does not include a plenum. Also, first arm 12 does not include an air deflector. As such, all of the airflow exiting drying cavity 20 passes through duct 60.

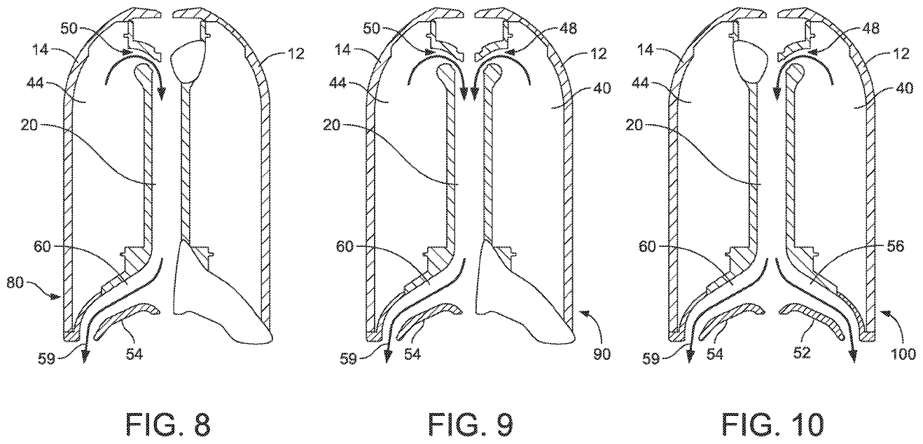

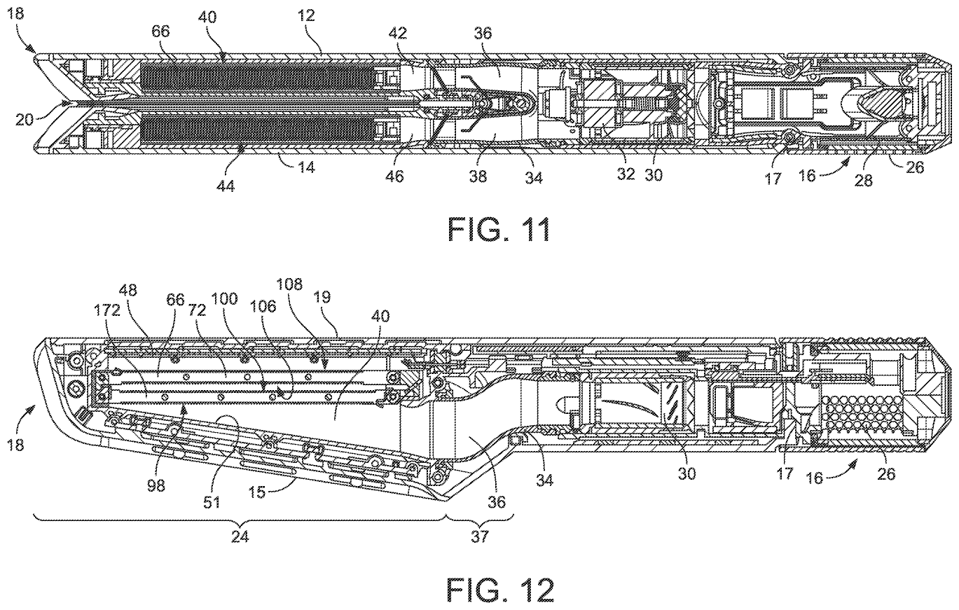

FIG. 8 shows a transverse cross-section of a hair styling appliance 80, in which features in common with hair styling appliances 10 and 60 use the same reference signs. In hair styling appliance 80, second arm 14 includes plenum 44 and duct 60, but first arm 12 includes neither a plenum nor an air deflector. As with hair styling appliance 60, all of the airflow exiting drying cavity 20 passes through duct 60, although in this case, the airflow is supplied into drying cavity 20 via second slot 50.

In another example, both of first and second arms 12 and 14 include a plenum but only one of first and second arms 12 and 14 includes an air deflector.

For example, FIG. 9 shows a transverse cross-section of a hair styling appliance 90, in which features in common with hair styling appliances 10, 70, and 80 use the same reference signs. In hair styling appliance 90, first and second arms 12 and 14 include respective first and second plenums 40 and 44. Second arm 14 includes air deflector 54, but first arm 12 does not include an air deflector. As such, all of the airflow exiting drying cavity passes through second duct 60.

In another example, only one of first and second arms 12 and 14 includes a plenum, but both of first and second arms 12 and 14 include an air deflector.

For example, FIG. 10 shows a transverse cross-section of a hair styling appliance 100, in which features in common with hair styling appliances 10, 70, 80, and 90 use the same reference signs. In hair styling appliance 100, first arm 12 includes first plenum 40, but second arm 14 does not include a plenum. As such, airflow exiting drying cavity 20 passes through first and second ducts 56 and 60 in a similar manner to that described in relation to hair styling appliance 10 of FIGS. 1-6, although in this case, the airflow is supplied into drying cavity 20 only via first slot 48.

It will be appreciated that, although specific combinations of first and second arms, plenums, outlets and air deflectors have been described, any other combination of such components may be adopted, depending upon the desired implementation. Selecting a particular combination of these elements may allow a manufacturer to balance manufacturing costs against desired performance.

In addition, although the use of a single motor 32 and impeller 30 has been described, it will be appreciated that a separate motor can be provided in or for each arm.

Also, although the hair styling appliances described above all use a base (such as handle section 16), the skilled person will appreciate that the arms may be directly connected to each other, rather than via such a base. In that case, motor 32 and impeller 30 can be mounted within one of the arms, or a separate motor and impeller can be mounted within each of the arms.

Although first and second arms 12 and 14 are generally symmetrical, the skilled person will appreciate that this need not be the case. For example, one of the arms may have greater volume than the other, and may contain, for example, motor 32, impeller 30, and a plenum, while the other arm may not contain those items. An air deflector can be in mounted on either of the arms in this approach.

Although the air deflectors described above take the form of linear elements that define a longitudinal duct, in other embodiments, a different form of air deflector may be used. For example, the air deflector(s) can take the form of one or more apertures formed through either or both of the arms. In that case, the air deflectors form part of a wall of each aperture upon which air exiting drying cavity 20 impinges and is redirected. Alternatively, the air deflector(s) can take the form of one or more longitudinal slats spaced from either or both of the arms.

Heater 66 may take any suitable form. Both first and second plenums 40 and 44 include heaters, but in other implementations, only one of the plenums has a heater. Also, where both plenums have heaters, the heaters need not be the same as each other.

Referring to FIG. 13, there is shown a further implementation of a longitudinal heater 166. Heater 166 is configured to be installed in a hair styling appliance, such as hair styling appliance 10, 60, 70, 80, or 90, such that heater 166 extends along an air outlet (e.g., first slot 48 or second slot 50) within a corresponding plenum (e.g., first plenum 40 or second plenum 44) for heating air before it exits the air outlet. The heater may extend parallel to the air outlet, or at an oblique angle to the air outlet. For example, the heater may extend at an angle of less than 25 degrees, or more particularly less than 10 degrees, to the slot. Where the slot is not linear, the heater may extend parallel, or at an oblique angle, to a line of best fit through the slot.

Heater 166 comprises a pair of parallel, longitudinally extending first and second heating elements 168, 170. First and second heating elements 168, 170 comprise respective first and second supports 172, 174, which are formed from a heat-resistant material such as a ceramic.

A first generally helical groove 176 is formed along an outer surface of first support 172, and a second generally helical groove 178 is formed along an outer surface of second support 174. First groove 176 has a constant pitch along its full length, such that its energy output per unit length is constant. In contrast, second groove 178 has a first pitch along a first heating zone 180 and a second pitch along a second heating zone 182.

A heater wire 184 is wound along first support 172 such that it is retained within first groove 176, starting at the right-hand end of first support 172. At the left-hand end of first support 172, heater wire 184 is connected across to second support 174 (the connection is not shown), and is then wound along second support 174 such that is retained within second groove 178.

The ends of heater wire 184 (i.e., at the right-hand end of heater 166) are connected to first and second drive cables 186, 188, respectively. Current supplied via first and second drive cables 186, 188 passes through heater wire 184 and causes it to heat up due to its resistance.

As a result of heater wire 184 having a constant pitch along the length of first support 172, first heating element 168 has a constant power density along its entire length. The pitch of heater wire 184 within first heating zone 180 results in a constant power density along the length of first heating zone 180. In the implementation of FIG. 13, the pitch of heater wire 184 within first heating zone 180 is the same as the pitch of heater wire 184 along first support 172, but it will be appreciated that this need not be the case. The pitch of heater wire 184 within second heating zone 182 also results in a constant power density along the length of second heating zone 182. However, as a result of the pitch of heater wire 184 within second heating zone 182 being greater than the pitch within first heating zone 180, the power density within first heating zone 180 is higher than the power density within second heating zone 182.

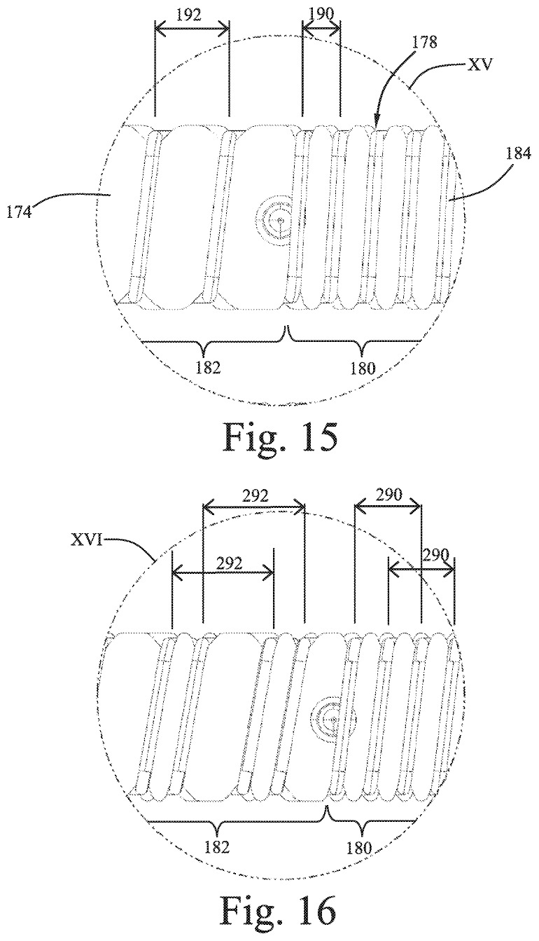

FIG. 15 shows a detailed view of circled portion XV in FIG. 13. A first pitch 190 of heater wire 184 within first heating zone 180 is approximately half that of a second pitch 192 of heater wire 184 within second heating zone 182. For example, in an implementation, first pitch 190 can be about 1 mm and second pitch 192 can be about 2 mm. It will be appreciated, however, that any other suitable ratio between first pitch 190 and second pitch 192 may be used to suit particular implementation requirements, and that any other suitable pitch values can be selected for first pitch 190 and second pitch 192.

Referring to FIG. 14, there is shown a further implementation of a longitudinal heater 266. Like heater 166, heater 266 is configured to be installed in a hair styling appliance, such as hair styling appliance 10, 60, 70, 80, or 90, such that heater 166 extends along an air outlet (e.g., first slot 48 or second slot 50) within a corresponding plenum (e.g., first plenum 40 or second plenum 44) for heating air before it exits the air outlet. Heater 266 shares several elements and features with heater 166, and such elements and features are indicated with like reference signs in relation to both heater 166 and heater 266.

Second heater 266 includes a first pair of generally helical grooves 276, 278 formed along the outer surface of first support 172, and a second pair of generally helical grooves 280, 282 formed along the outer surface of second support 174. First grooves 276, 278 are substantially parallel with each other along their lengths, and second grooves 280, 282 are similarly substantially parallel with each other along their lengths. First grooves 276, 278 have a constant pitch along their full length, such that their energy output per unit length is constant. In contrast, second grooves 280, 282 have a first pitch along first heating zone 180 and a second pitch along second heating zone 182.

A first heater wire 296 is wound along first support 172 such that it is retained within groove 276, starting at the right-hand end of first support 172. Similarly, a second heater wire 298 is wound along first support 172 such that is retained within groove 278, starting at the right-hand end of first support 172. At the left-hand end of first support 172, first and second heater wires 296, 298 are connected across to second support 174, and are then wound along second support 174 such that they are retained within grooves 280, 282 respectively.

The ends of first and second heater wires 296, 298 (i.e., at the right-hand end of heater 266) are connected to first and second drive cables 186, 188, respectively. Current supplied via first and second drive cables 186, 188 passes through first and second heater wires 296, 298 and causes them to heat up due to their resistance. In the implementation of FIG. 14, first and second heater wires 296, 298 are connected in electrical parallel with each other.

As a result of first and second heater wires 296, 298 having a constant pitch along the length of first support 172, first heating element has a constant power density along its entire length. The pitch of first and second heater wires 296, 298 within first heating zone 180 results in a constant power density along the length of first heating zone 180. In the implementation of FIG. 14, the pitch of heater wires 296, 298 within first heating zone 180 is the same as the pitch of heater wires 296, 298 along first support 172, but it will be appreciated that this need not be the case. The pitch of heater wires 296, 298 within second heating zone 182 also results in a constant power density along the length of second heating zone 182. However, as a result of the pitch of heater wires 296, 298 within second heating zone 182 being greater than the pitch within first heating zone 180, the power density within first heating zone 180 is higher than the power density within second heating zone 182.

FIG. 16 shows a detailed view of circled portion XVI in FIG. 14. A first pitch 290 of heater wires 296, 298 within first heating zone 180 is approximately two thirds of that of a second pitch 292 of heater wires 296, 298 within second heating zone 182. For example, in an implementation, first pitch 290 can be about 2 mm and second pitch 292 can be about 3 mm. It will be appreciated, however, that any other suitable ratio between first pitch 290 and second pitch 292 may be used to suit particular implementation requirements, and that any other suitable pitch values can be selected for first pitch 290 and second pitch 292.

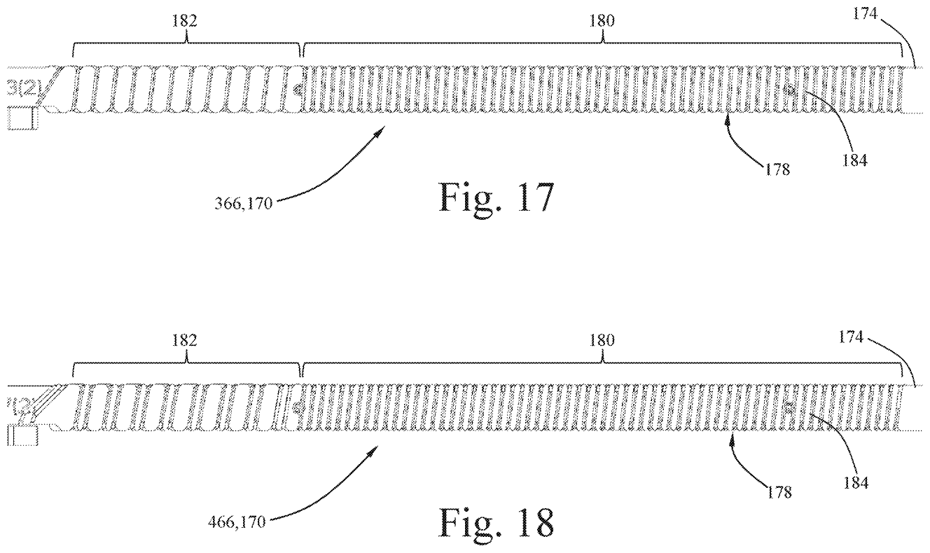

Referring to FIG. 17, there is shown a further implementation of a longitudinal heater 366. Like heaters 166 and 266, heater 366 is configured to be installed in a hair styling appliance, such as hair styling appliance 10, 60, 70, 80, or 90, such that heater 366 extends along an air outlet (e.g., first slot 48 or second slot 50) within a corresponding plenum (e.g., first plenum 40 or second plenum 44) for heating air before it exits the air outlet. Heater 366 shares several elements and features with heaters 166 and 266, and such elements and features are indicated with like reference signs in relation to heaters 166, 266 and 366.

Heater 366 is effectively heater 166 with first heating element 168 removed. In contrast with heater 166, heater wire 184 of heater 366 only extends in one direction, so its ends are connected to first and second drive cables 186, 188 (not shown in FIG. 17, for clarity) at opposite ends of second element 170.

Referring to FIG. 18, there is shown a further implementation of a longitudinal heater 466. Like heaters 166, 266 and 366, heater 466 is configured to be installed in a hair styling appliance, such as hair styling appliance 10, 60, 70, 80, or 90, such that heater 466 extends along an air outlet (e.g., first slot 48 or second slot 50) within a corresponding plenum (e.g., first plenum 40 or second plenum 44) for heating air before it exits the air outlet. Heater 466 shares several elements and features with heaters 166, 266 and 366, and such elements and features are indicated with like reference signs in relation to heaters 166, 266, 366, and 466.

Heater 466 is effectively heater 266 with first heating element 168 removed. In contrast with heater 266, first and second heater wires 296, 298 of heater 466 only extend in one direction, so their ends are connected to first and second drive cables 186, 188 (not shown in FIG. 18, for clarity) at opposite ends of second element 170.

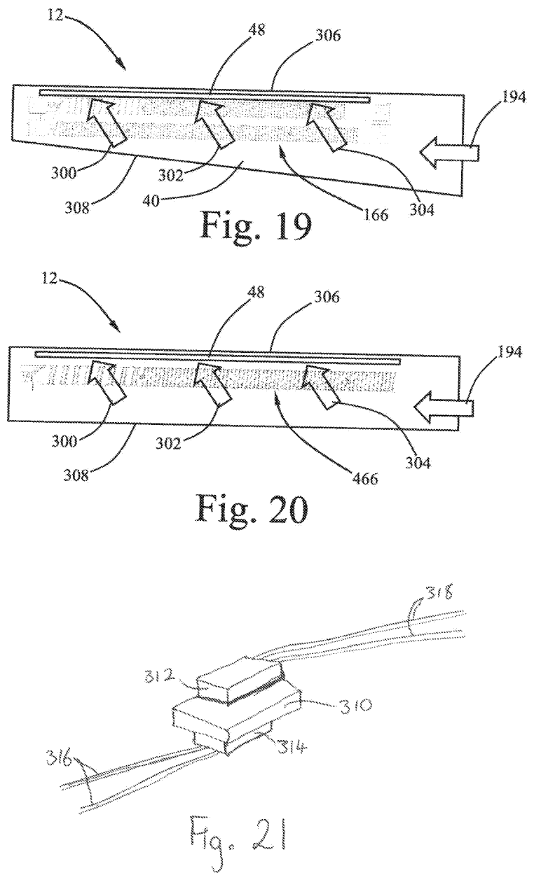

Turning to FIG. 19, there is shown a simplified schematic of a first arm 12, showing first plenum 40 and first slot 48. Heater 166 is installed in first plenum 40 along an edge of first slot 48. First plenum 40 is at least partly defined by a first wall 306 adjacent first slot 48 and a second wall 308. First and second walls 306, 308 converge in a direction towards the tips of first arm 12 (i.e., away from the air inlet), with first wall 306 being at an acute angle relative to second wall 308. This convergence causes a reduction in the cross-sectional area of the plenum 40 in a direction away from the air inlet, and the heater 166 is positioned such that the first heating zone 180 is closer than the second heating zone 182 to the air inlet.

In use, air enters first plenum 40 from first duct 36 (which, for clarity, is not shown in FIG. 19) as shown by arrow 194. The air passes through plenum 40, across heater 166 as shown by arrows 300, 302, and 304, and through first slot 40. It will be appreciated that the air crosses the heater across its length, not just where indicated by arrows 300, 302, and 304. The heated air is used to style hair, as described above.

Heater 166 is configured and positioned such that air exiting first slot 48, having been heated by first heating zone 180, is closer in temperature to air exiting first slot 48 having been heated by second heating zone 182 than would be the case if the first and second heating zones 180, 182 had the same power density. Air that ultimately exits first slot 48 adjacent second heating zone 182 (i.e., in the general vicinity of arrow 300) is preheated by first heating zone 180 as it passes through plenum 40. In addition, pressure variance along the length of the plenum may cause air at far end of the plenum (from the air inlet) to move more slowly across the heater, causing it to be heated more than air closer to the air inlet. By reducing the power density in the second heating zone 182 compared to the first heating zone 180, the impact of such uneven heating is reduced, resulting in a more even temperature of air exiting first slot 48.

FIG. 20 shows an alternative implementation of first arm 12, in which first and second walls 306, 308 do not converge towards each other along their lengths. In addition, heater 166 is replaced with heater 466. Operation is otherwise similar to that described in relation to FIG. 19, with the exception that the dynamics of the air passing through plenum 40 and then past heater 466 will be different as a result of the different planform of the plenum. As a result, the distribution of airflow along the air exit will be different in the FIGS. 19 and 20 implementations. The relative lengths and/or power densities of the first and second zones may therefore need to be adjusted to account for those airflow distribution differences.

FIG. 21 is a perspective view of a PCB connector which may connect wiring from the motor and a heater harness. The connector comprises a double-sided PCB 310, a first secure wire connection means 312 and a second secure wire connection means 314 on the opposing side of the PCB 310. Wiring from the motor 318 is connected within the first secure wire connection means 312 and the heater harness 316 is connected to the second secure wire connection means. Such a PCB connector may be positioned in the body of the hair styling appliance. Advantageously, such a connection is serviceable and also robust in comparison to prior art wire connection means, such as a ‘pin and socket’ arrangement.

Other planforms of plenum will suggest themselves to the skilled person. For example, the walls can diverge rather than converge. Either or both of the walls may be convex, concave, or both, along at least part of their lengths.

Similarly, the depth of the plenum may vary along its length so as to vary the cross-sectional shape and/or area.

It will be appreciated that any number of parallel heater wires (i.e., two or more) can be used in any combination of heating zones to meet the requirements of different implementations. For example, in lower voltage (e.g., battery powered) implementations, it may be desirable to have multiple heater wires in parallel in either or both (or all, where there are more than two) of the heating zones to allow for increased current, and hence power output, for the relatively low drive voltage. Conversely, in higher voltage (e.g., mains powered) implementations, it may be desirable to have fewer, including just one, heater wires in either, both, or all of the heating zones. Any combination of single and multiple wires can also be used to meet implementation requirements.

In addition, different combinations of wires within the heating zones can be driven depending upon a mode in which the hair styling appliance is operating. For example, where a pair of heating wires extends along a substrate (such as support 172 or 174), different drive current can be applied to each wire. For example, in a low power mode, one wire can be driven, whereas in a high power mode, both wires can be driven. Alternatively, wires of different resistance can be used, in which case driving them independently or together offers three power levels. The skilled person will appreciate that whatever number of wires is used, drive current can be modulated in any known manner, such as burst fire, leading or trailing edge mains dimming, PWM, etc., depending upon the control circuitry, power supply type and voltage, and other factors known to the skilled person.

The relative power densities of first heating zone 180 and second heating zone 182 can be adjusted in a number of different ways, any and all of which can be combined in any suitable combination to meet the requirements of a particular implementation. For example, the resistance, and hence heat output, of the heating wire (or wires, where multiple are used) can vary along the length of the heating element. Such variance can be continuous (e.g., the heater wire continuously increases or decreases in thickness along at this part of its length) or stepped (e.g., one thickness along part of its length and a different thickness along at least one other part of its length).

The number of parallel-connected heating wires can be varied. For example, a higher number of parallel-connected heating wires can be used in the first heating zone than in the second heating zone, such that (for a given winding pitch and wire thickness) the power density of the first heating zone is higher than the second heating zone.

A cross-sectional and/or surface area of the heating element(s) can vary along the length of the heater. For example, by reducing the cross-sectional and/or surface areas of the heating element(s) in a direction away from the air inlet, the power density (for a given winding pitch) will reduce along the length of the heating element(s). The variance of the cross-sectional and/or surface area of the heating element(s) can be continuous and/or stepwise, depending upon the needs of any particular implementation.

The heater wire resistance can vary along the length of the heater such that the heater wire in the first heating zone has a higher power density than that in the second heating zone.

Where the heating element comprises a coil (e.g., as is the case in the implementations of FIGS. 13-19), a winding density of the coil can be higher within the first heating zone than the second heating zone.

A ratio of the lengths of first heating zone 180 and second heating zone 182 can also be adjusted to provide the required improved temperature consistency along the air outlet.

As described above, the winding pitch can be varied along the length of the heater in order to adjust the power density (i.e., for a given heater wire, a smaller winding pitch will result in a higher power density).

In other implementations, the at least one heating element can use a different heating technology than the illustrated heater wire. For example, a heater trace can be printed or otherwise disposed onto or into a surface of a heat-resistant substrate. Alternatively, a heater trace can be etched from a resistive material disposed on a heat-resistant substrate. In each case, the heating element can be more densely concentrated in the first heating zone than the second heating zone in order to provide the required difference in energy density along a length of the heater.

Although several aspects have been described with reference to the accompanying drawings, the invention is not limited to those aspects.

1. A hair styling appliance comprising:
a first arm and a second arm coupled together for reciprocal movement towards and away from each other, and arranged to receive hair within a region between each other;
a plenum disposed within at least one of the first arm and the second arm, the plenum comprising an air inlet for receiving airflow from a fan unit and an air outlet for emitting airflow towards the hair within the region; and
a longitudinal heater extending along the air outlet within the plenum for heating air before it exits the air outlet;
wherein the heater comprises at least one heating element, the at least one heating element comprising:
a first heating zone having first power density; and
a second heating zone having a second power density lower than the first power density; and
wherein the heater is configured and positioned such that, when the hair styling appliance is in use, air exiting the air outlet having been heated by the first heating zone is closer in temperature to air exiting the air outlet having been heated by the second heating zone than would be the case if the first and second heating zones had the same power density.

2. The hair styling appliance of claim 1, wherein the at least one heating element is more densely concentrated in the first heating zone than the second heating zone.

3. The hair styling appliance of claim 2, wherein the at least one heating element comprises a coil, and wherein a winding density of the coil is higher within the first heating zone than the second heating zone.

4. The hair styling appliance of claim 2, wherein an average resistance per unit length of the at least one heating element is higher in the first heating zone than in the second heating zone.

5. The hair styling appliance of claim 1, wherein the first power density is constant within the first heating zone, and wherein the second power density is constant within the second heating zone.

6. The hair styling appliance of claim 1, wherein the first power density varies continuously over at least part of the length of the heater, and wherein the second power density varies continuously over at least part of the length of the heater.

7. The hair styling appliance of claim 1, wherein each of the first arm and the second arm comprises an inner wall, wherein the inner walls at least partly define the region.

8. The hair styling appliance of claim 7, wherein the air outlet extends along the inner wall of at least one of the first arm and the second arm.

9. The hair styling appliance of claim 8, wherein the heater extends parallel or at an oblique angle to the air outlet.

10. The hair styling appliance of claim 1, wherein each of the first and second arms comprises a leading edge, past which hair enters the region while the hair is being pulled through the hair styling appliance in use, and a trailing edge, past which hair leaves the region while the hair is being pulled through the hair styling appliance in use, wherein the air outlet is disposed closer to the trailing edge than the leading edge.

11. The hair styling appliance of claim 1, wherein a cross-sectional area of the plenum reduces in a direction away from the air inlet, and wherein the heater is positioned such that the first heating zone is closer than the second heating zone to the air inlet.

12. The hair styling appliance of claim 11, wherein:
the plenum is at least partly defined by a first wall adjacent the air outlet, and a second wall opposing the first wall; and
the first wall is at an acute angle relative to the second wall.

13. The hair styling appliance of claim 12, wherein the first and second arms terminate at respective tips, and wherein the first and second walls converge towards the tip(s) of the respective arm or arms within which the plenum(s) are disposed.
